(19) United States
(12) Patent Application Publication
(10) Pub. No.: US 2008/0235973 A1
(43) Pub. Date: Oct. 2, 2008

(54) Measuring Tape Indicating Standard Building Dimensions

(76) Inventor: Ray Hollingsworth, Victoria (AU)

Correspondence Address: KIRK HAHN, 14431 HOLT AVE, SANTA ANA, CA, 92705, US

(21) Appl. No.: 12/065,727

(22) PCT Filed: Aug. 29, 2006
(86) PCT No.: PCT/AU2006/001245

§ 371 Date: Mar. 12, 2008

(30) Foreign Application Priority Data
Sep. 5, 2005 (AU) 2005904848
Dec. 6, 2005 (AU) 2005101008

(51) Int. Cl. G01B 3/10

(52) U.S. Cl. 33/759

(57) ABSTRACT

According to the innovation there is provided a measuring device of use in building of timber frame buildings comprising: A flexible tape marked with scale markings on at least one face of the tape said scale markings comprising at least one measuring scale; A casing adapted for storage of the tape in spirally wound manner and for permitting external exposure of an unwound portion of the tape; and Retracting means for withdrawing the tape into the casing; Where in the tape is marked on at least one face with bands that—(a) extend substantially across the width of the tape between opposing edges thereof; (b) are of a colour that contrasts with a colour of the said face of the tape away from said bands; and (c) are regularly spaced along at least a part of the length of the tape at a centre-to-centre spacing of 450 mm. ‘Scale markings’ here are intended to be taken as comprising both marks placed at spaced intervals and numerals indicating length from an end of (or other point along) the tape.

### FIELD OF THE INVENTION

The invention here described relates to an improved measuring tape device, the improvement simplifying the process of setting out stud and floor joist positions for timber frames of buildings according to Australian practice.

### BACKGROUND

In the building of timber framed buildings, it is a requirement to mark out positions for joists along the length of bearers when constructing a floor structure and to mark out positions for studs along the length of top and bottom wall plates when constructing wall frames. The present invention is directed to easing this process.

In Australian practice, there is a standard spacing of 450 mm (centre to centre) for both floor joists and wall frame studs. A standardized thickness for joists (i.e. measured in the direction along a bearer) is 45 mm. A standardized thickness for wall studs (again, measured in the direction along a top or bottom plate) is 35 mm. “Standardized” here means, in relation to a dimension, that the dimension is prescribed in a Building Code. This may be done directly or by virtue of a Building Code prescribing compliance with an Australian Standard that in turn prescribes the dimension.

Marking out positions for these structural elements is tedious, time consuming, and error prone. The invention is directed to addressing the need for a means to ease the process and give a high assurance of accurate results.

Builders find it convenient in their work to use metal measuring tapes of the retracting variety, and the invention is based on an improvement to this type of tape that assists in laying out the positions of studs and joists.

### SUMMARY OF THE INVENTION

According to the invention, there is provided a measuring device for use in building of timber framed buildings comprising:

a flexible tape marked with scale markings on at least one face of the tape said scale markings comprising at least one measuring scale;

a casing adapted for storage of the tape in spirally wound manner and for permitting exposure externally of the casing of an unwound portion of the tape; and
retracting means for withdrawing the tape into the casing;
wherein the tape is marked on at least one face with bands that—
(a) extend substantially across the width of the tape between opposing edges thereof;
(b) are so coloured as to contrast both with a colour of the said face of the tape away from said bands and with the markings of the measuring scale overlapped by the bands;
(c) are regularly spaced along at least a part of the length of the tape at a centre-to-centre spacing of one specified building element type; and
(d) have a width as measured lengthwise of the tape equal to the width of the specified building element.

“Scale markings” here are intended to be taken as comprising both marks placed at spaced intervals and numerals indicating length from an end of (or other point along) the tape.

For example, said bands may be regularly spaced along at least a part of the length of the tape at a standard centre-to-centre spacing of frame studs and with said bands having along-tape lengths of the thickness of a specified size of frame stud.

For further example, said bands may be regularly spaced along at least a part of the length of the tape at a standard centre-to-centre spacing of floor bearers and wherein said bands have along-tape lengths of the thickness of a specified size of floor bearer.

In a preferred embodiment applicable in Australia for both frame studs and floor bearers, said bands are regularly spaced along at least a part of the length of the tape at a standard centre-to-centre spacing of 450 mm and said bands have along-tape lengths of either 35 mm or 45 mm.

It is further preferred that—
(a) said tape has an end fitting adapted to hook over an end of an elongate component and having a face positioned to correspond in use of the fitting to an end point of a said measuring scale; and
(b) a first one of said bands extends from a free end of the tape and has a an edge that in use of the fitting is spaced from said face of said fitting by the width of the said first one of said bands.

In one way this can be achieved, said bands are marked on said tape using a translucent surface coating applied over said scale markings. Other possible approaches exist, such as printing the scale markings after or simultaneously with the bands and/or the general background colour of the tape surface and in contrasting colour(s).

In this specification, including in the appended claims, the words “comprising” and “comprises” when used in relation to a set of elements integers features or steps are to be taken to indicate that the elements integers features or steps are present, but are not to be taken to preclude the possibility of other elements integers features or steps being present also.

The preferred embodiment of the invention will be described in the following detailed description, by reference to the attached Figures, of which:

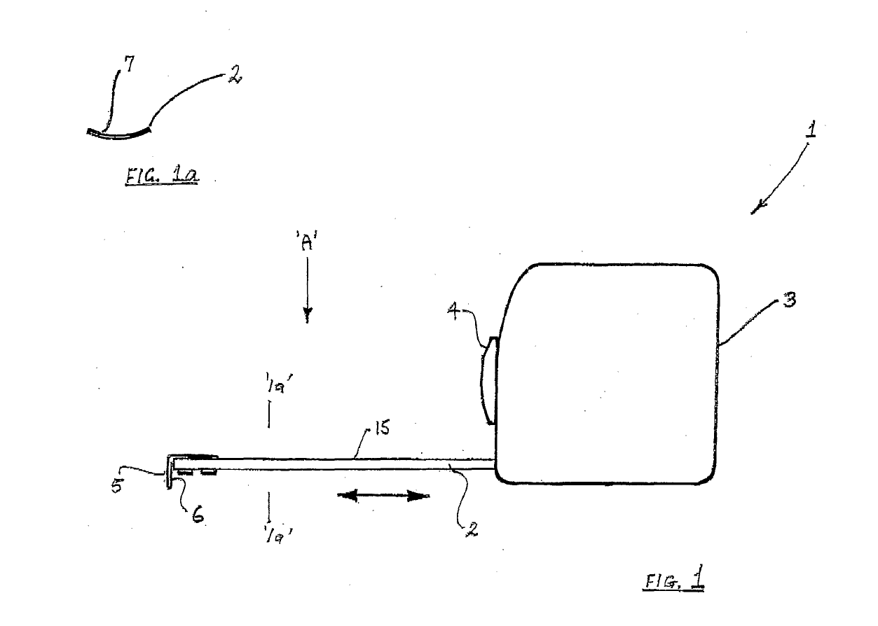

FIG. 1 is a side elevation of a measuring tape according to the invention;

FIG. 1a is a cross-sectional view of a tape portion of the measuring tape shown in FIG. 1, the section being taken at station “1a-1a” in FIG. 1;

FIG. 2 is a view in the direction of arrow “A” of a free end portion of the tape shown in FIG. 1;

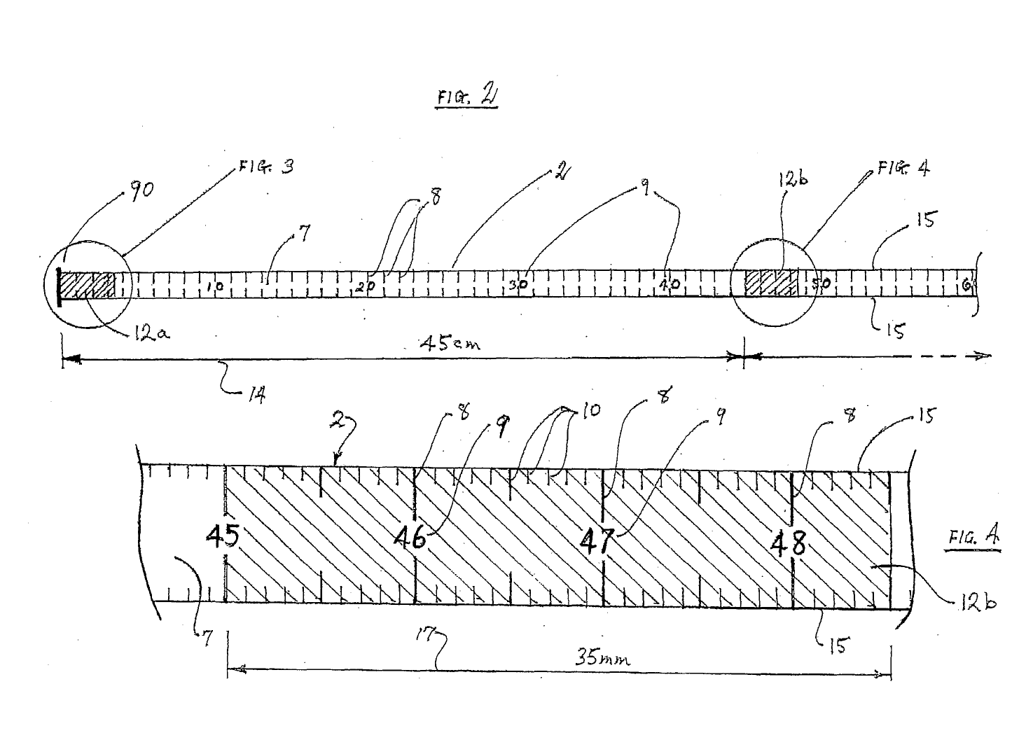

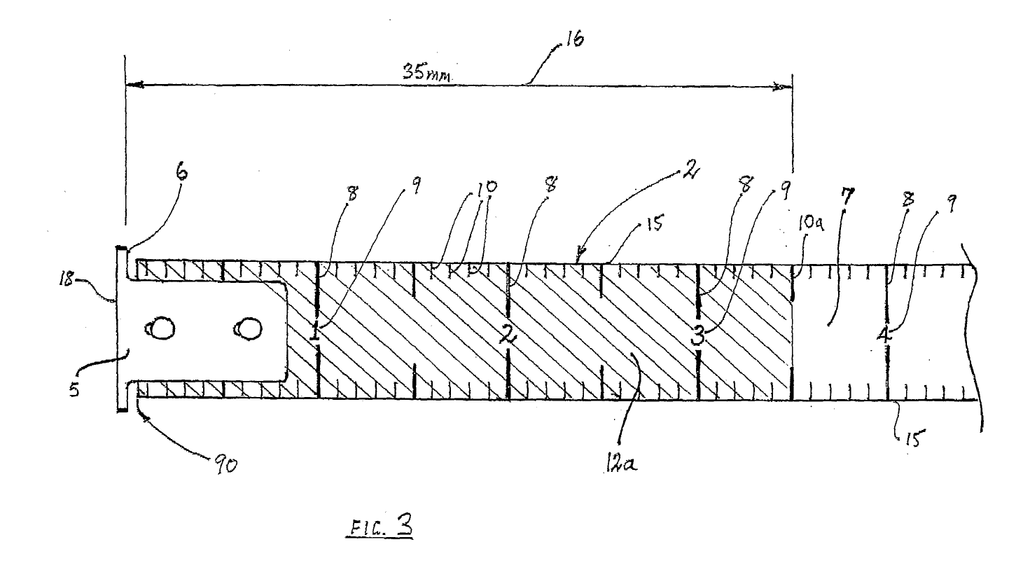

FIG. 3 is a magnified detail view of a section of the tape portion as shown in FIG. 2;

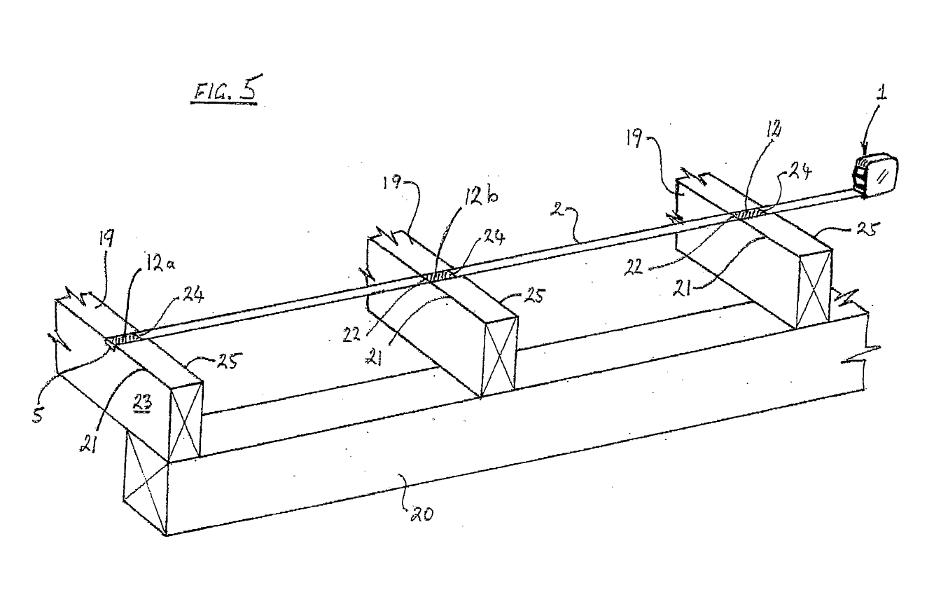

FIG. 4 is a magnified detail view of a section of the tape portion as shown in FIG. 2;

FIG. 5 is a view of the tape shown in FIG. 1 positioned on part of a floor structure.

### DETAILED DESCRIPTION OF PREFERRED EMBODIMENTS

FIG. 1 shows a retractable measuring tape device 1 according to the invention. Except as described below, device 1 is of a type well known to carpenters, builders, tradespersons and hobbyists. Measuring device 1 comprises a metal tape 2 and a casing 3 within which all or a part of the tape 2 can be stored. That part of tape 2 within casing 3 is wound into a compact spiral, and a retracting means (not shown, and typically including a spring) is provided with the casing 3 to retract the tape 2 when required. Tape 2 generally is made with an arcuate cross section a shown in FIG. 1a, so that the portion outside casing 3 has some resistance to bending, but the portion of tape 2 inside casing 3 flattens as it is wound up. A brake mechanism (not shown) including a button 4 is provided to prevent a portion of tape 2 that is pulled out of casing 3 being retracted into casing 3 until the brake mechanism is released by a user. Secured at a free end 90 of the tape 2 is an end fitting 5. Fitting 5 allows the tape 2 to be hooked over an end of an elongate article (not shown) so that distances along that article can be measured. In this condition, a face 6 of fitting 5 is positioned longitudinally to correspond to an end of a measuring scale marked on the tape 2, as further described below. The above features of the device 1 are known in the art, and are not themselves of the essence of the present invention.

As shown in FIG. 2, a surface 7 of tape 2 is marked with marks 8 and numerals 9 to provide a measuring scale. The particular pattern shown has numerals 9 every ten centimetres along the length of the tape 2, and marks 8 every centimetre along the length of the tape 2. Not shown in FIG. 2, but shown in the magnified detail views of FIGS. 3 and 4, are spaced-apart marks 10 indicating millimeters.

Many measuring scale marking patterns are known, and the one shown in the Figures and described above is illustrative only. There is no intention to limit the scope of the present invention to the particular pattern shown.

As best seen in FIG. 2, coloured bands 12 are marked on tape 2. Only two of the bands 12 are shown in FIG. 2, these being labelled 12a and 12b. However, it is to be understood that bands 12a and 12b are representative of a series of such bands 2 marked on tape 2, and spaced apart along the entire portion of the length of tape 2 that is usable for measurement. Bands 12 (including those not shown) are provided at a spacing of 45 centimetres, between each neighbouring pair of the bands 12, along the tape 2. This dimension is shown in FIG. 2 by dimension line 14. This spacing of the bands 13 is chosen to match the standard spacing of both wall studs and floor joists in Australian timber building practice.

Bands 12 are represented by cross-hatching in FIGS. 2, 3 and 4 for convenience, but are preferred to be solid coloured bands, of a colour readily distinguishable from the colour of parts of the surface 7. Bands 12 extend substantially across the full width of surface 7, between opposing edges 15. The bands 12 do not prevent marks 8 and 10 and numerals 9 from being provided within the boundaries of bands 12 or from being distinguishable by a user. Thus the measuring device 1 can be used in entirely conventional fashin for making measurements, without reference to the bands 12, when required.

Each of bands 12 has a length of 35 millimetres measured in a direction along a length of the tape 2, as shown by the dimension lines 16 and 17 in FIGS. 3 and 4 respectively. This dimension is chosen as being the same as the standard thickness of wall studs (other than widow and door studs) in Australian timber building practice.

Band 12a is provided at free end 90 of tape 2, and is shown as being marked only on the tape 2 itself. However, end fitting 5 may optionally be coloured similarly to the remainder of band 12a. As is known in the manufacture of retractable measuring tapes, end fitting 5 is slideable lengthwise on tape 2 between two positions. In the position shown in FIG. 3, fitting 5 is as far left (away from casing 3) as it can go. This position is used when fitting 5 is hooked over an end of an elongate article (not shown, but such as a top or bottom plate of a wall frame). In this position, face 6 rests against an end face of the elongate article and the zero point of the measuring scale of tape 2 corresponds to face 6 of fitting 5. When fitting 5 is slid as far as possible to the right (not shown) a face 18 of fitting 5 corresponds to the zero point of the measuring scale marked on tape 2. In this position the measuring device 1 can be used to measure distances from a wall (or the like, not shown) against which face 18 of fitting 5 is pressed (i.e. an “inside” measurement).

Bands 12 on tape 2 provide clear and easy-to-use means for correctly determining and marking the positions of studs along a top or bottom plate of a wall frame, or of joist along a floor bearer. FIG. 5 shows measuring device 1 in use to confirm the correct positioning of joists 19 along a bearer 20. Left edges 21 of joists 19 are aligned with left edges 22 of bands 12 of tape 2. As shown, end fitting 5 is hooked over one of joists 19, with face 6 bearing against a joist face 23. It will be noted that because bands 12 are 35 mm in length, their right edges 24 do not align with right edges 25 of joists 19. However, this is found in practice to cause no particular difficulty.

Although bands 12 have been described as 35 mm long, they may optionally be made 45 mm long instead of 35 mm long, to correspond to the widths of standard joists such as joists 19.

To ensure that marks 8 and 10 and numerals 9 are not obscured by bands 12, bands 12 may be provided by the use of a surface colouring agent that provides a translucent or transparent finish, for example a suitable varnish. Alternatively, contrasting colours may be used for bands 12, surface 7, marks 8 and 10 and numerals 9 with these elements being placed on tape 2 by conventional means so that nothing is obscured by bands 12.

1. A measuring device for use in building of timber framed buildings comprising:
a flexible tape marked with scale markings on at least one face of the tape said scale markings comprising at least one measuring scale;
a casing adapted for storage of the tape in spirally wound manner and for permitting exposure externally of the casing of an unwound portion of the tape;
retracting means for withdrawing the tape into the casing;
wherein the tape is marked on at least one face with bands that —
(a) extend substantially across the width of the tape between opposing edges thereof;
(b) are so coloured as to contrast both with a colour of the said face of the tape away from said bands and with the markings of the measuring scale overlapped by the bands;
(c) are regularly spaced along at least a part of the length of the tape at a centre-to-centre spacing of one specified building element type; and
(d) have a width as measured lengthwise of the tape equal to the width of the specified building element.

2. A measuring tape according to claim 1 wherein said bands are regularly spaced along at least a part of the length of the tape at a standard centre-to-centre spacing of frame studs and wherein said bands have along-tape lengths of the thickness of a specified size of frame stud.

3. A measuring tape according to claim 1 wherein said bands are regularly spaced along at least a part of the length of the tape at a standard centre-to-centre spacing of floor bearers and wherein said bands have along-tape lengths of the thickness of a specified size of floor bearer.

4. A measuring tape according to claim 1 wherein said bands are regularly spaced along at least a part of the length of the tape at a standard centre-to-centre spacing of 450 mm and wherein said bands have along-tape lengths of either 35 mm or 45 mm.

5. A measuring tape according to claim 1 wherein;
(a) said tape has an end fitting adapted to hook over an end of an elongate component and having a face positioned to correspond in use of the fitting to an end point of a said measuring scale; and
(b) a first one of said bands extends from a free end of the tape and has an edge that in use of the fitting is spaced from said face of said fitting by the width of the said first one of said bands.

6. A measuring tape according to claim 1 wherein said bands are marked on said tape using a translucent surface coating applied over said scale markings.
